(19) United States
(12) Patent Application Publication
(10) Pub. No.: US 2026/0073785 A1
(43) Pub. Date: Mar. 12, 2026

(54) Package Beacon

(71) Applicant: Craig Heimberger, O'Fallon, IL (US)

(72) Inventor: Craig Heimberger, O'Fallon, IL (US)

(73) Assignee: Lancer LLC, O'Fallon, IL (US)

(21) Appl. No.: 18/827,663

(22) Filed: Sep. 6, 2024

(51) Int. Cl. G08B 21/18

(52) U.S. Cl. CPC G08B 21/18

(57) ABSTRACT

The Package Beacon device streamlines package identification for delivery drivers and parcel service personnel. When attached to a package, the Beacon can emit a flashing or solid light, a buzzing/beeping sound, and or a vibration alarm to notify personnel of its physical location. Each beacon is equipped with a unique code, such as a barcode, QR code, and or passive/active RFID, which ensures individual identification. Once attached, the beacon and package are digitally paired using a scanner or RFID reader, and this pairing is uploaded into the parcel system before the package and its beacon are physically loaded onto the delivery vehicle. Upon arrival at the delivery destination, the beacon activates its notification process to alert the employee of its exact location on the vehicle. This process can be initiated by the onboard GPS system or manually/remotely by the delivery employee.

### SPECIFICATION

Patent Class: G06Q Informational and communication technology specifically adapted for administrative, commercial, financial, managerial or supervisory purposes.

### BACKGROUND

The relentless growth of e-commerce has placed a stranglehold on traditional parcel delivery. With ever more packages flooding the system, current methods are buckling, and nobody feels this more so than the industry employees who must sort and deliver this influx of packages each day. The increasing problem is that there are too many packages to deliver and not enough time to deliver them all. The system is overburdened, as are the people who work each day to run and operate it. Job stress is a leading cause of high-volume labor turnover and contributes to long-term health issues among the industry's employees. This turmoil within the industry is taking a toll on delivery workers and their families. In recent years, there have been several instances in which delivery workers have been so overwhelmed with the number of packages needed to be delivered in a standard workday, that they have literally dumped undelivered packages in dumpsters and secluded areas. These incidents have made national news and created bad publicity for the major delivery companies such as FedEx, UPS, Amazon, DHL, and the US Postal Service.

As the population grows and the world continues to move more and more towards the convenience of online, retail shopping, this problem will only get worse. The industry and its employees need to find ways to create a more efficient workplace and one way that can save time and money is to implement a device which can simplify package identification, and location, and retrieval in a delivery facility or vehicle.. A device that can shorten the amount of time needed searching for packages or manually reading labels in order to get them to the next step in the delivery process. This constant label reading and searching causes mental fatigue and increased frustration over the course of a full workday.

Current delivery techniques will not sustain the ever-increasing number of packages that must be delivered expeditiously. The only current solution that the industry can conceive of is to put more delivery workers and trucks on the road, but due to the job stressors listed previously, the parcel service companies have found themselves in the middle of a job turnover crisis.

In today's rapidly advancing technological landscape, there is a growing concern that real jobs for individuals are at risk of being replaced by automation. It is crucial to streamline current methods in a way that preserves employment opportunities for people and does not pave the way for automation, such as drone deliveries, to take over.

### The Concept

This innovative device directly addresses the challenges faced by parcel delivery employees when locating packages upon arrival at delivery locations. Currently, delivery personnel often spend valuable time manually reading labels with the naked eye to identify each package designated for specific delivery points. The ancient method of locating a package on a delivery vehicle remains the same as it was at the beginning of the parcel service industry.

To streamline this process, this application provides a solution: attaching a reusable electronic beacon to each package. The goals are straightforward: reduce delivery times, alleviate employee frustration, minimize mis-delivered and misplaced packages, and enhance overall efficiency and job satisfaction for delivery workers.

The Package Beacon device streamlines package identification for delivery workers and parcel service personnel. When attached to a package, the Beacon can emit a flashing or solid light, a buzzing/beeping sound, and or a vibration alarm to notify personnel of its physical location. Each beacon is equipped with a unique code, such as a barcode, QR code, and or passive/active RFID, which ensures individual identification. Additionally, the beacon can be detected and precisely located by secondary devices such as smart tablets, smart phones, or wireless signal readers like RFID readers. The beacon also has the potential to be precisely located by heads-up display lenses and smart glasses. Once attached, the beacon and package are digitally paired using a scanner or RFID reader, and this pairing is uploaded into the parcel system before the package and its beacon are physically loaded onto the delivery vehicle. Upon arrival at the delivery destination, the beacon activates its notification process to alert the employee of its exact location on the vehicle. This process can be initiated by the onboard GPS system or manually/remotely by the delivery employee. The Package Beacon is designed to be compatible with existing tracking and delivery operating systems ensuring seamless integration and enhancing the efficiency of package delivery operations. Additionally, the device is easy to install, allowing delivery personnel to quickly and efficiently attach it to packages. The Package Beacon is also built to be durable, withstanding the rigors of transportation and handling to ensure its reliable performance and daily long-term use.

### How the Package Beacon Works

### Step 1—Attach and Scan

Upon arrival at the delivery facility, a package is removed from the freight truck and scanned into the system. The beacon features a compact, ergonomic, and sturdy mechanical design, allowing effortless attachment to shipping boxes, bags, and envelopes—ensuring versatility. Once affixed, it can be folded and strategically positioned for optimal visibility to delivery employees. Moreover, the design mitigates the risk of accidental detachment from the package. After attachment, the beacon, each equipped with a unique QR code and or RFID tag, undergoes simultaneous scanning, RF reading, or the combination of both, alongside the package label. This process internally links the beacon with the specific package throughout the entire delivery process within the company's system.

### Step 2—Load the Package

Following scanning, the package is positioned on a conveyor belt system and retrieved by the employee responsible for loading the delivery vehicle. The employee strategically loads the vehicle, ensuring that each beacon faces the center aisle to maximize visibility for the delivery personnel.

### Step 3—Package Arrival

Upon the package's arrival at its delivery destination, the truck's onboard delivery operating system communicates with the beacon, signaling that the package has reached its intended location.

Subsequently, the beacon activates either flashing or solid LEDs, emitting visible light for the delivery employee to see. Additionally, a buzzer is triggered, emitting a vibration and or high-pitched beeping sound as an auditory signal—especially useful if the beacon lacks visibility. A secondary device such as a tablet/smart phone, smart glasses, or heads up display lens(es) may also be used to target and detect the exact location of the package.

### Step 4—Removal and Deactivation

Upon retrieving the package, the delivery employee removes and deactivates the beacon. Once deactivated, the beacon is no longer paired in the system with its designated package for that delivery sequence. It is then stored in a bin or pouch and at the end of the workday, the delivery employee returns the deactivated beacons to the delivery facility where they will be reused the following day. The devices will continue this cycle daily throughout their operational lifespan.

### Market Activity

FedEx currently employs a device tracker called SenseAware, which is a removable device attached in a time-consuming manner usually employing a translucent pouch which is adhered to the package. In order to remove it, it must be torn or cut with a razor knife blade. However, SenseAware does not address the delivery worker's challenge of quickly locating packages. Instead, it relies on radio signals to track a package's global location. Consequently, it serves primarily as a management and customer tool for package tracking. Due to their unfavorable cost-benefit and limited practical application, SenseAware devices are reserved for high-profile premium packages and are ineffective for short-range, on-demand package locating by delivery employees. It does not directly improve delivery times, or productivity, or alleviate the demands placed on employees. As a result, it does not directly compete with the innovative device described here.

A patent awarded in February 2022, by Amazon, 11,348,058 is a package tracking patent. This patent is different than this application as it deals with delivery confirmation, from the Amazon patent “a delivery confirmation of a package at a delivery location may be determined based on a communication protocol between a user device and a package device associated with the package.” The patent application presented here deals with a quick method for a delivery vehicle delivery worker to locate a package in the delivery vehicle.

In 2023, UPS made a substantial investment of $140 million in an RFID (Radio Frequency Identification) system for their package trucks. This new investment was designed to enable package trucks to detect when a package has been loaded in order to solve the problem of misplaced packages. This Package Beacon would be an advancement of the UPS model and could possibly replace or be integrated along with their investment in RFID technology. Reports indicate that this system has significantly reduced the occurrence of misloaded packages by more than half. Furthermore, UPS′ investment in RFID technology highlights the industry's future growth and need to develop more advanced tracking solutions.

### SUMMARY OF THE INVENTION

### Overview

The Package Beacon is an affordable tracking device that is designed to interface with a computerized parcel delivery system in order to track packages for parcel employees, especially delivery workers, making their jobs easier. By helping the loaders and deliverers find packages, the Package Beacon will speed up the delivery process and save the parcel delivery service time and money. The main purpose of the Beacon is not intended to track a package's location in the world (although GPS capabilities can be complimented as a secondary function through the integration of current delivery systems), but to bring attention to a package and or group of packages in the vicinity of the delivery vehicle delivery workers in order to save time finding packages.

What sets the Package Beacon apart from other tracking devices is that the Package Beacon is designed to interface with a local signal of connection from the delivery vehicle's GPS locator, which tells a delivery worker the vehicle has arrived at a delivery location and that then activates a signal on the Package Beacon. The delivery worker can then find the package with his sight, in the case of a flashing light, or hearing, with the beeping or vibrating sounds, or by using a smart tablet, smart phone, or wireless signal reader like an RFID reader. The beacon also has the potential to be precisely located by heads-up display lenses and smart glasses. The Beacon has the potential to be activated and utilized by other parcel employees before the package is loaded onto the delivery vehicle. It can also be integrated in and utilized by other warehousing and order fulfillment industries and shipping services including air and over the road shipping freight, warehousing, moving and storage, order fulfillment other services that require or need to quickly identify the location of objects or goods for retrieval.

### Product Details

A package beacon to quickly locate a package within a delivery facility or vehicle, the package beacon comprising:
a specific barcode/QR code which is permanently adhered to the Package Beacon's face on each of its' two sides;
a unique RFID code designated to each beacon;
a clip section that can attached the Package Beacon to a package;
a center section with hinges on both ends to allows the Package Beacon to fully fold in both directions;
an end piece that is attached to the rest of the Package Beacon through a hinge with the middle section and that has an extension that holds a Halo section, the Halo section being a component that lights up and is held in place by the extension of the end piece;
the Halo section that contains all electrical components and the halo emits the lights, buzzer and vibrations;
one or more processors capable of receiving signals from the delivery vehicle's delivery system and activating the light, beeping device or vibration device and the one or more processors capable of notifying the delivery vehicle's GPS system that the package has been taken for delivery;
a method for turning off the light, beeping device or vibration device;
a battery;
battery charging capabilities;
a battery cover.

A system of package identification comprising these steps:
a scanner, RFID reader, or combination of both, associated with the pre-loading and loading of the delivery vehicle, pairs and sends to a vehicle's GPS system a set of barcode/QR code scans, one from the package beacon and one from the label of the package beacon is attached to—This scanning could be automated, as is the case with the current UPS' changes. The beacon would have to be attached by an individual though but may be scanned automatically by the emitted RF signals at the scanning points on the sorting conveyor;
the vehicle's GPS system processor's correlate the two scans with the delivery instructions of the package's label and the route instructions given to the delivery worker;
packages are loaded in the normal way with the package beacons attached to the packages facing toward the truck's interior so the package beacon can be seen by the delivery vehicle's delivery worker;
when the delivery vehicle reaches a GPS determined delivery location the GPS system processor's activate the package beacon to do one or more of the following actions: activate a solid or flashing light, emit a beeping sound, or vibrate;
the delivery vehicle delivery worker deactivates the package beacon upon picking it up for final delivery to the package's recipient;
deactivating the package beacon notifies the vehicle's delivery operating and GPS system that the package is ready for delivery;
the delivery vehicle delivery worker removes the package beacon from the package and saves it to be returned to a collection point at the package loading facility;
the GPS can notify other systems related to package delivery as requested.

Other embodiments include:
the device being deactivated by the GPS system once the GPS system is notified by the user that the beacon has fulfilled its purpose and the sensory communication protocol is no longer necessary. This can be initiated through a secondary device such as a reader, scanner, or company smart device;
the device may be programmed to deactivate its sensory communication protocol after a specific amount of time (i.e. 60 seconds) in order to conserve battery power.

Additional Embodiments include:
The package beacon could respond to specific request given by the delivery worker to the GPS system such as activating a beacon when not at the delivery stop, activating multiple beacons when several deliveries to a neighborhood are made;
The Package Beacon can be charged wirelessly;
The Package Beacon could potentially be charged by a remote wireless power signal;
The Package Beacon could be charged by solar power of kinetic energy;
The delivery worker can see the location of the Package Beacon in the delivery vehicle on a wireless device such as a tablet;
The delivery worker can wear smart glasses that help him/her see exactly where the Package Beacon is on the truck;
A thin loop may be added to the package that can adhere to a package being delivered when the clip cannot be installed;
Other parcel employees may also utilize the Package Beacon between the initial package drop and time of delivery.

Further Details of the Package Beacon's Physical Design and Functionality The Package Beacon is made with three segments, connected by two rotating hinges. The physical design allow the Package Beacon to neatly and fully fold in two opposing directions. On one end of the device is a halo which lights up upon receiving a signal. The halo contains all electric components, the one or more processors and the battery and the apparatus to charge the battery. The halo also hosts the beeping and vibration device(s). On the other end is a clip light attachment which is designed to attach to a package, loop, shopping bag, envelop or cardboard box. The clip uses tension in order to give it the strength to attach to a box. It also uses a special design with staggered, and tapered teeth which allow the clip to lock on to a thin loop. The lock-in mechanism of the clip's staggered, tapered, interlocking teeth. This is a significant part of the device which allows it to lock onto the thin loop.

The third segment is a small segment that that houses the two hinges on either end. The three segment hinge design allows the Package Beacon to unfold into different position (a full 360 rotation while attached to a package during the delivery process. This rotating function makes the light up mechanism of the Halo versatile and visible in several ways. For instance the clip can attach to the exposed flap on the side of a cardboard package and the Halo segment can fold in a downward position on the side of the box or package. This allows the halo to face the center aisle of the delivery vehicle and assures the light is not covered up by another package.

In some cases, there may be a package lacking an exposed end of flap in which the Package Beacon can attach to. When this occurs a thin loop may be added to the Package Beacon and adhered to the package, or the thin loop can be added to the package label, or be present and pre-manufactured on all boxes and packages or on the package label.

### DESCRIPTION OF NUMBERING CALLOUTS ON THE DRAWINGS

1. Location for the barcode
2. Halo
3. Clip
4. Pivoting hinges
5. Middle segment
6. Package Beacon
8. Beacon icon
9. Tablet
10. Smart glasses
13. Extension from end segment that holds the halo
14. End segment
16. Thin loop
17. RFID component inside halo
18. Raised section of thin loop
19. Place where adhesive is attached
20. Package
21. Envelope package
22. Cell phone
23. Head support
24. Transparent visor
25. Barcode
26. Shopping bag package

### BRIEF DESCRIPTION OF DRAWINGS

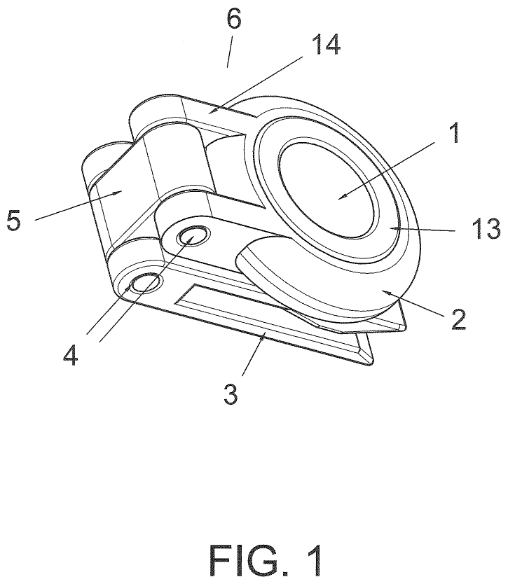

FIG. 1 is a perspective view of a folded-up Package Beacon.

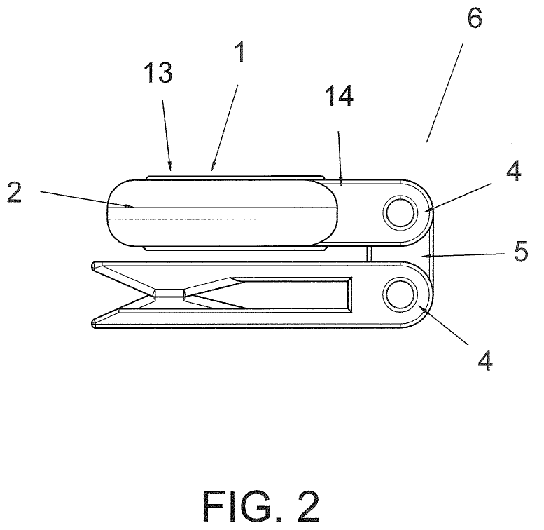

FIG. 2 is a side view of the Package Beacon.

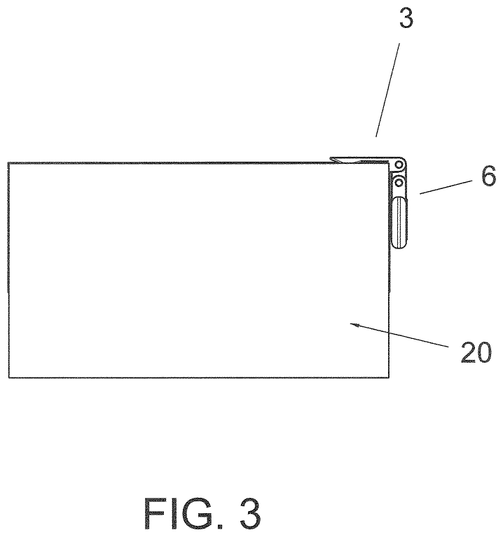

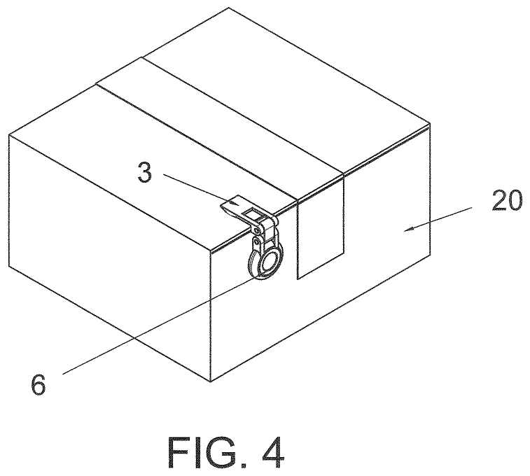

FIGS. 3 and 4 are examples of the Package Beacon of FIG. 1 paired with a package.

FIG. 4 is a perspective view of a folded Package Beacon.

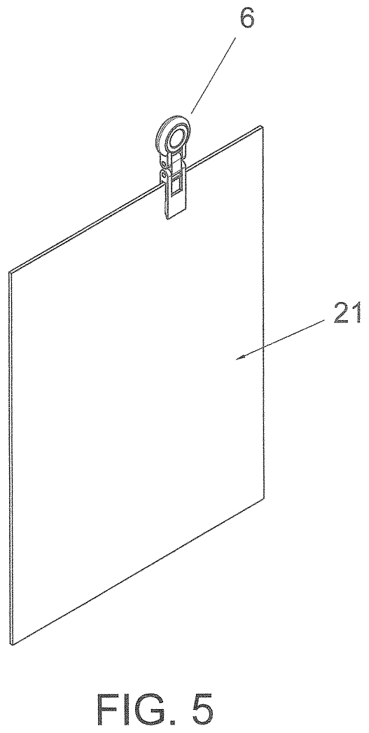

FIG. 5 is a perspective view of the Package Beacon on an envelope type enclosure.

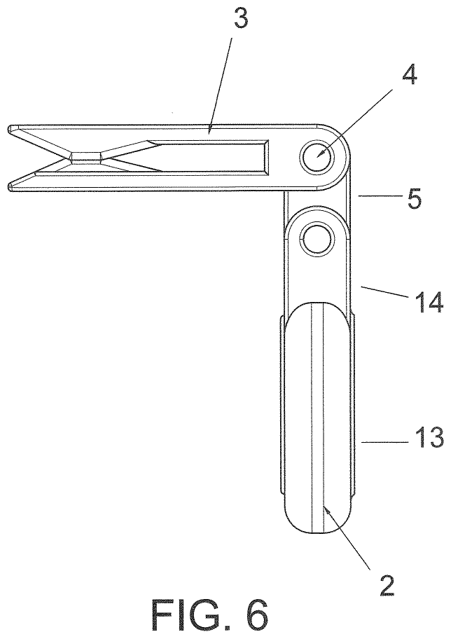

FIG. 6 is a side elevation view of the Package Beacon in a 90 degree folded position.

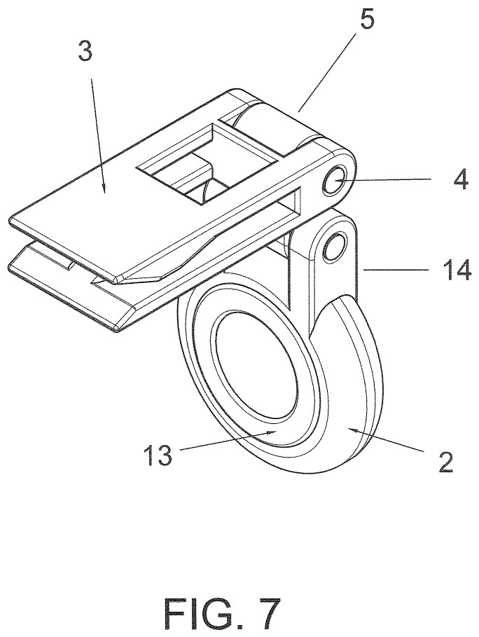

FIG. 7 is a perspective view of the Package Beacon in a 90 degree folded position.

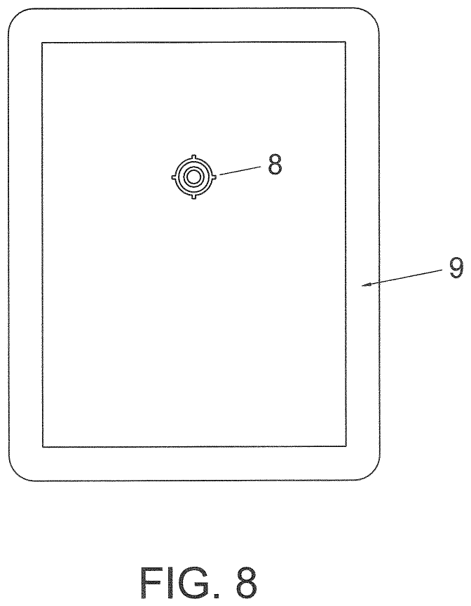

FIG. 8 illustrates how a smart device such as a tablet can show an image of the Package Beacon pointing the way to where the Package Beacon is.

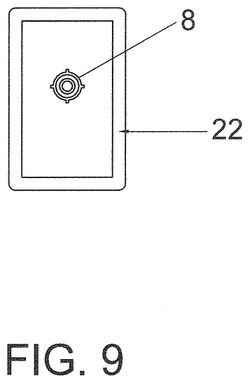

FIG. 9 shows how a smart phone 22 can show an image of the Package Beacon pointing the way to where the Package Beacon is.

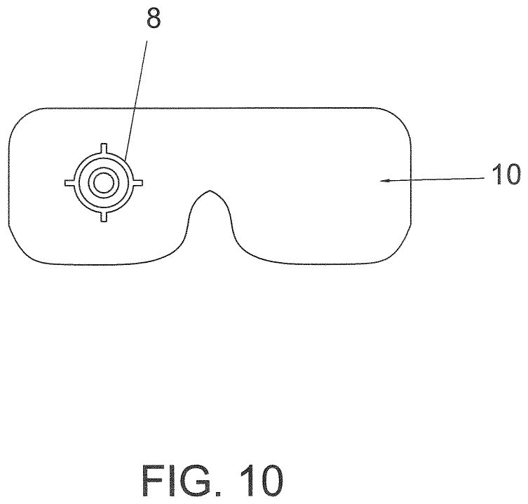

FIG. 10 shows how a pair of smart glasses 10 can show an image of the Package Beacon pointing the way to where the Package Beacon is.

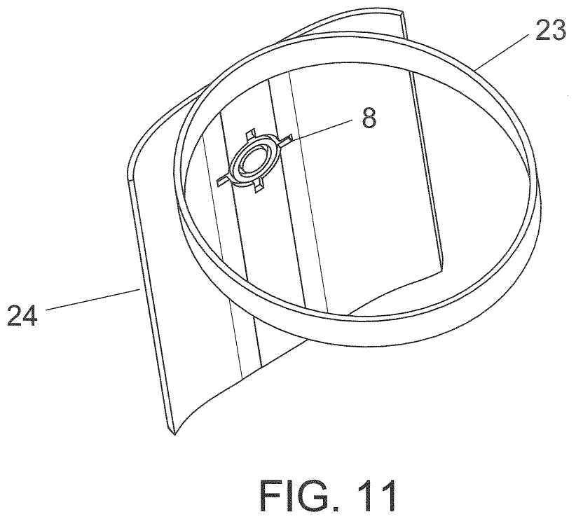

FIG. 11 is a perspective view of a clear/transparent lens for a Visor or shield with an attachment to rest on the head that ca show an image of the Package Beacon pointing the way to where the Package Beacon is.

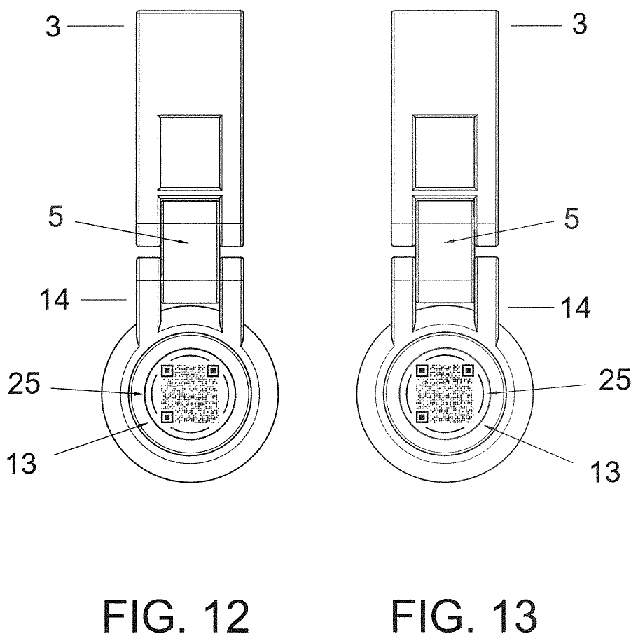

FIG. 12 illustrates how the barcode can be located on the top of the halo on the Package Beacon.

FIG. 13 illustrates how the barcode can be on the bottom of the halo of the Package Beacon

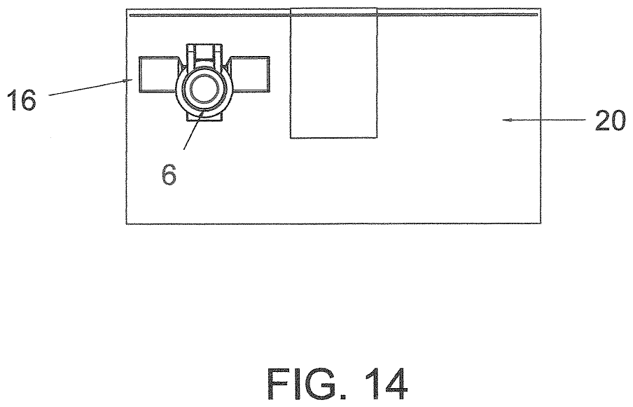

FIG. 14 shows how the folded Package Beacon is held on to the package by a thin loop.

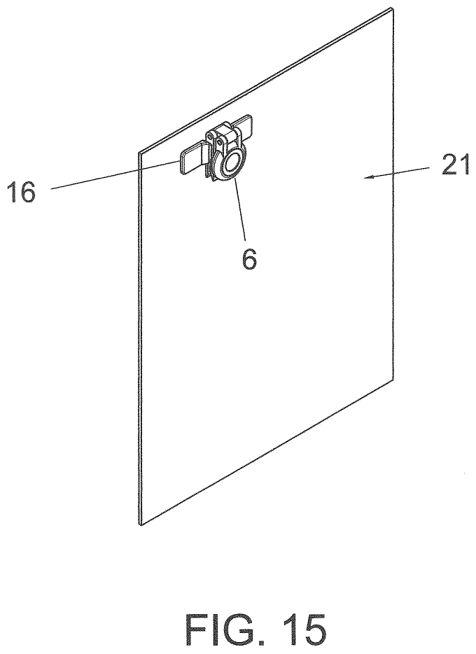

FIG. 15 shows how the folded Package Beacon is held on to an envelope package by a thin loop.

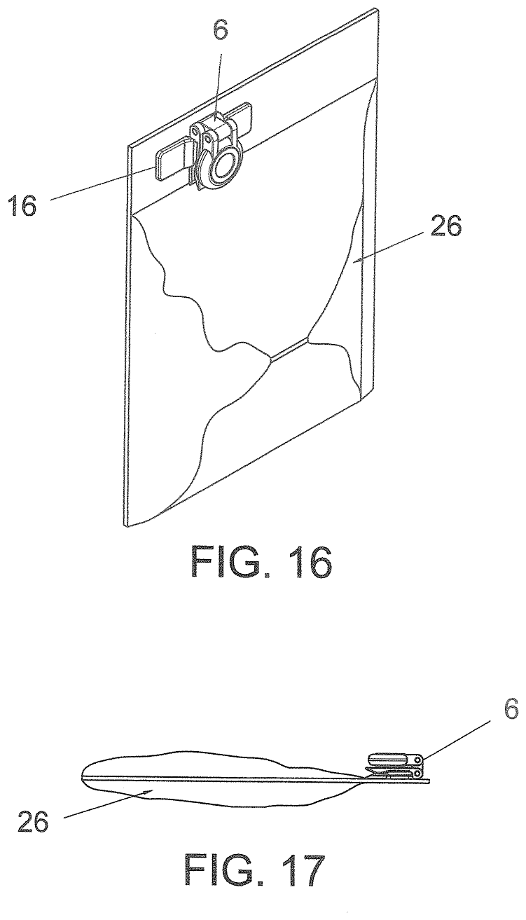

FIG. 16 shows a perspective view of a folded Package Beacon held onto a shipping bag package by a thin loop.

FIG. 17 shows a side view of a folded Package Beacon held onto a shipping package by a thin loop.

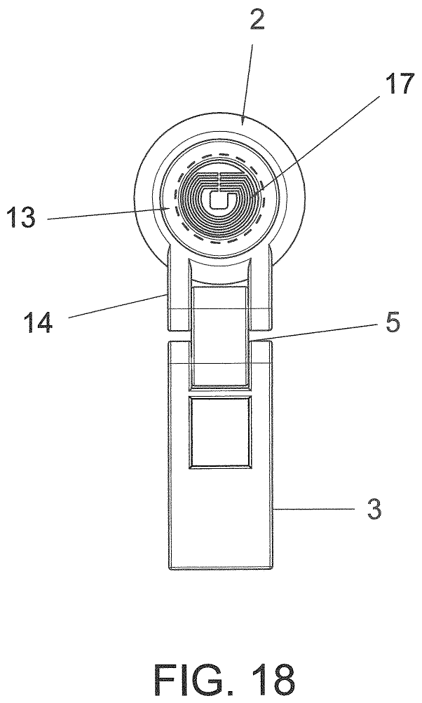

FIG. 18 shows the RFID signaler which is inside of the Halo. Also inside are the one or more microprocessors, the battery, the LED lights, and the device(s) that emit the buzzer/beeper and vibrating sound.

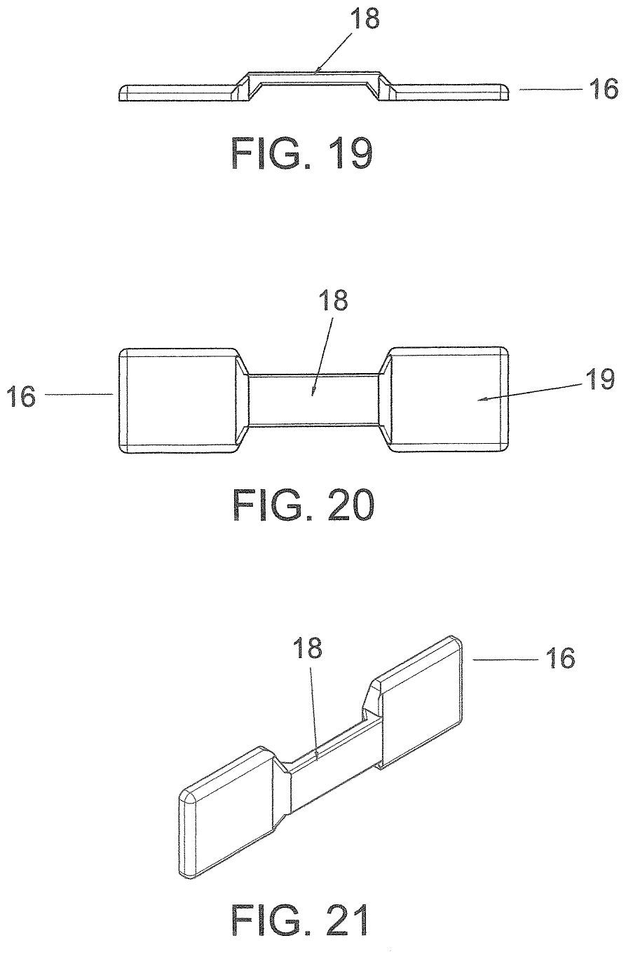

FIGS. 19, 20 and 21 give a better depiction of what the thin loop looks like that can hold the Package Beacon in place when there is not a flap to place the clip under.

### DETAILED DESCRIPTION

FIG. 1 shows a perspective view of the Package Beacon 6. The section has three parts. The clip section 3, the middle segment 5, with two pivoting hinges 4 on either end of the middle device 5, and the segment 14 that has an extension 13 that holds the Halo 2 which lights up, and also contains one or more microprocessors, the battery and the beeping and vibrating device, and on both sides of the Halo the spot 1 for the barcode.

FIG. 2 shows a side view of a Package Beacon 6 folded. The Halo 2 sits on the top and the segment 14 that has an extension 13 to hold the Halo 2 connects to the middle segment 5 through one of the hinges 4, the clip with interlocking, tapered teeth 3 is attached through the second hinge 4 to the middle segment 5. The Halo 2 is held in place by the Halo-Holder extension 13 of the segment that holds the Halo Package Beacon. 14

FIG. 3 shows the Package Beacon 6 attached at a 90 degree angle to a package 20, with one edge of the clip 3 on the outside of the package and the other edge of the clip (not seen) is underneath a flap of the package.

FIG. 4 is a perspective of the Package Beacon 6 with one edge of the clip 3 above the edge of the package 20 the other edge of the lip (not seen) underneath a flap of the package.

FIG. 5 is a view of the Package Beacon 6 attached to an envelope type package 21.

FIG. 6 is a side view of the Package Beacon 6 folded to a 90 degree angle. The clip section 3 is at the top of FIG., the middle section 5 is turned down, through the use of the pivoting hinge 4, the remainder of the Package Beacon, which is the holder for the Halo 14 is turned down, with the section of the holder that holds the Halo 13 also pointed down with the Halo 2 at the bottom of the FIG.

FIG. 7 is a perspective view of the Package Beacon at a 90 Degree angle. The clip section 3 is at the top of FIG., the middle section 5 is turned down, through the use of the pivoting hinge 4, the remainder of the Package Beacon, which is the holder for the Halo 14 is turned down, with the section of the holder that holds the Halo 13 also pointed down with the Halo 2 at the bottom of the FIG.

FIG. 8 shows that a tablet 9 can be used to help the delivery worker target locate a package on the truck based on the package Beacon icon 8 location on the tablet 9, the icon moves as the delivery worker goes back in the vehicle.

FIG. 9 shows that a phone 22 can be used to help the delivery worker target locate a package on the truck based on the package Beacon icon 8 location on the phone 22, the icon moves as the delivery worker goes back in the vehicle.

FIG. 10 shows how Smart Glasses 10 can also be used to help quickly target locate a package on the truck by observing the Package Beacon icon 8 on the Smart Glasses.

FIG. 11 is a perspective view of a clear/transparent lens for a Visor or shield 24 with an attachment to rest on the head 23 that can show an image of the Package Beacon pointing the way to where the Package Beacon is.

FIG. 12 illustrates where the QR/barcode 25 goes on the top of the Package Beacon on the Halo 2, in the middle of the extension part 13 that holds the halo 2. The Package Beacon is laid out flat in this figure with the clip 3, the middle section 5 and the end section 14 in a linear layout.

FIG. 13 illustrates where the QR/barcode 25 goes on the bottom of the Package Beacon on the Halo 2, in the middle of the extension part 13 that holds the halo 2. The Package Beacon is laid out flat in this figure with the clip 3, the middle section 5 and the end section 14 in a linear layout.

FIG. 14 shows a Package Beacon 6 being held in place by the thin loop 16 on a package 20.

FIG. 15 shows a Package Beacon 6 being attached to an envelope type package 21 being held in place by the thin loop 16

FIG. 16 shows a perspective view of a Package Beacon 6 being attached to a shopping bag package 26.

FIG. 17 shows a side view of a Package Beacon 6 being attached to a shopping bag type package 26.

FIG. 18 shows the RFID 17 that is inside the Halo 2. The Halo 2 also contains the flashing light, the beeper, the vibrator and the battery.

FIG. 19 is a side view of the thin loop 16 and it shows the elevated portion 18 which goes over the clip section of the Package Beacon. 18 which slides between the interlocking mechanism of the clip section of the Package Beacon.

FIG. 20 is a view from the bottom of the thin loop 16 showing the elevated section 18 as well the locations of the adhesive 19.

FIG. 21 is a perspective view of the thin loop 16 showing the elevated section 18.

I claim

1. A package beacon to quickly locate a package within a delivery vehicle, the package beacon comprising:
a specific barcode/QR code which is permanently adhered to the Package Beacon's face on each of its' two sides;
a clip section that can attach the Package Beacon to a package;
a center section with hinges on both ends which allows the Package Beacon to fully fold in both directions;
one or more processors capable of receiving signals from the delivery vehicle's positioning/mapping system and activating the light, buzzing/beeping device or vibration device and the one or more processors capable of notifying the delivery vehicle's delivery operating system that the package has been taken for delivery and the one or more processors capable of notifying the smart device or an intermediary local positioning device(s) that communicates to the smart device the location of the Package Beacon inside the truck;
a method for turning off the light, beeping device or vibration device;
a battery;
battery charging capabilities;
a battery cover.

2. The package beacon of claim with an end piece that is attached to the rest of the package beacon through a hinge in the middle section and that has an extension that holds a component that lights up and is held in place by the extension of the end piece.

3. The package beacon of claim 1 where the component that lights up contains electrical materials.

4. The package beacon of claim 1 where one or more processors can send notifications to additional systems.

5. A system of package identification comprising these steps:
a scanner, RFID reader, or combination of both associated with the person loading the delivery vehicle, pairs and sends to a vehicle's positioning/mapping system and or delivery operating system a set of barcode/QR code and or FID code scans, one from the package beacon and one from the label of the package which the beacon is attached to;
the vehicle's positioning/mapping system and or delivery operating system processor's correlate the two scans with the delivery instructions of the package's label and the delivery route instructions given to the delivery vehicle delivery worker;
packages are loaded in the normal way preferably with the package beacons attached to the side of the packages facing toward the truck's interior aisle so the package beacon can be seen by the delivery vehicle's delivery worker;
when the delivery vehicle reaches a system determined delivery location the positioning/mapping system processors activate the package beacon to do one or more of the following actions: emit a flashing or solid light, emit a buzzing/beeping sound, vibrate, and or communicate local positioning coordinates;
the delivery vehicle delivery worker deactivates the package beacon upon retrieval for final delivery to the package's recipient;
deactivating the package beacon notifies an operating system that the package is ready for delivery;
the delivery vehicle delivery worker removes the package beacon from the package and saves it to be returned to a collection point at the package loading facility;
the package beacon is prepared for the next delivery use;
the delivery operating system can notify other systems related to package delivery as requested.

6. The system of claim 2 where package beacon could respond to specific request given by the delivery worker to the delivery operating system such as activating a beacon when not at the delivery stop.

7. The package beacon of claim 2 where the GPS system can activate multiple beacons when several deliveries to a neighborhood are made.

8. The package beacon of claim 1 can be charged wirelessly.

9. The package beacon of claim 1 can be charged by a remote wireless power signal, kinetically, or by solar power.

10. The system of claim 2 where the can see the location of the package beacon in the delivery vehicle on a wireless device such as a tablet or smart phone.

11. The system of claim 2 where the package handler can wear smart glasses, monocle, visor, or handheld lens that help him/her see exactly where the package beacon is on the truck or within a distribution or sorting facility.

12. The system of claim 2 where a thin loop that may adhere to the package or be pre-manufacture with the package being delivered when the clip cannot be installed.

13. The system of claim 2 where the package beacon may be deactivated by the positioning/mapping system or the delivery operating system once the delivery operating system is notified by the user that the beacon has fulfilled its purpose and the sensory or local positioning communication protocols are no longer necessary. This can be initiated through a secondary device such as a reader, scanner, company smart device, or by pressing a deactivation button which could be preinstalled in the package beacon.

14. The system of claim 2 where the package beacon may be programmed to deactivate its sensory communication protocol after a specific amount of time (i.e. 60 seconds) in order to conserve battery power.

15. Warehousing/shipping/moving company package retrieval and order fulfillment at locations other than a delivery vehicle.
